(19) United States
(12) Patent Application Publication
(10) Pub. No.: US 2010/0252339 A1
(43) Pub. Date: Oct. 7, 2010

(54) Auxiliary Drive Device

(76) Inventors: Eric Bibeau, Winnipeg (CA); Reza Ghorbani, Winnipeg (CA)

Correspondence Address: ADE & COMPANY INC., 2157 Henderson Highway, WINNIPEG, MB, R2G1P9, CA

(21) Appl. No.: 12/742,212

(22) PCT Filed: Nov. 7, 2008
(86) PCT No.: PCT/CA2008/001936

§ 371 Date: May 10, 2010

Related U.S. Application Data
(60) Provisional application No. 60/986,848, filed on Nov. 9, 2007.

(51) Int. Cl. B62D 59/04

(52) U.S. Cl. 180/12; 180/11

(57) ABSTRACT

An auxiliary drive device is disclosed that connects to a motorised vehicle to supplement the drive of the motorised vehicle depending on the speed and acceleration of the motorised vehicle by using stored energy. The auxiliary drive device obtains energy by regenerative braking when the motorised vehicle decelerates, extracting energy from the motorised vehicle by using hybrid through the road, and by recharging from the power grid. The auxiliary drive device uses the stored energy to supplement the drive of the motorised vehicle depending on the motorised vehicle speed, acceleration, drive cycle, the amount of energy stored, and if the motorised vehicle is towing a load. A controller maximizes fuel savings and towing performance of the motorised vehicle. The controller determines when the auxiliary drive device needs to provide the mortised vehicle with power assistance, resistance via braking and when to conserve the stored energy for later use.

This application claims the benefit under 35 U.S.C. 119(e) of U.S. provisional application Ser. No. 60/986,848, filed Nov. 9, 2007. The present application is based on and claims priority from this application, the disclosure of which is expressly incorporated herein by reference.

### FIELD OF THE INVENTION

The present invention relates to an auxiliary drive device for connection to a vehicle having a primary motor to supplement the drive of the primary motor, for example to allow hybridization of the motorised vehicle, to permit the storage and use of grid power, and to provide power assistance when towing a trailer, and further relates to an auxiliary drive device which is separable from the vehicle with a trailer to provide drive to the trailer when the trailer is not attached to a towing vehicle and also relates to an auxiliary power unit to power electrical loads for stationary and mobile applications.

### BACKGROUND

The use of motorised vehicles for transportation has been known for many years and various configurations have evolved to carry passengers and goods. In the field of towing a trailer, a standard arrangement used is that of a motorised vehicle along with at least one trailer pulled thereby. In most vehicle configurations, the motorised vehicle has an internal combustion engine and a braking system which can be designed to also carry a limited weight trailer to transport a load.

Current motorised vehicles rely heavily on non-renewable fossil fuels which are relatively expensive, supply will peak, cause energy security risks, produce harmful emissions, and contribute to the increase in greenhouse gases that result in climate change. Thus it is desirable to improve the efficiency of motorised vehicles to reduce fuel consumption and to displace fossil fuel use with electric sources. In addition, electric drive motors are very efficient and allow the use of electricity when grid enabled, permitting the use of renewable energy. To achieve these goals, governments and industry invest in research and development of fuel efficient engines, hybrid vehicles, plug-in hybrid vehicles and pure electric vehicles.

Motorised vehicles are often designed with relatively large engine size to better carry a trailer and a load, often used a limited number of times per year, as for example, to pull a large recreational boat. However, these motorised vehicles with relatively large engine size are less efficient leading to higher emissions and fuel costs. When towing a load, it is important to also provide motorised vehicles with sufficient power to pull a load on an ascent and for passing another vehicle which requires making the engine of the motorised vehicle sufficiently large. However this larger engine size is not required on level ground. The motorised vehicle will thus operate less efficiently overall resulting in poorer fuel mileage.

U.S. Pat. No. 7,147,070 belonging to Leclerc discloses an example of a motorised semi-trailer in which an additional drive unit is provided on a trailer at the rear trailing end thereof. The configuration of the drive only permits its use on a large semi-trailer as no means are provided for use on other vehicles when extra demand is required on the engine but no trailer is present. Furthermore the auxiliary drive unit is positioned at the rear trailing end of the trailer to be pivotal with the trailer relative to the vehicle so that negotiating a turn with the towing vehicle can cause instability in the trailer due to the direction of auxiliary drive being misaligned with the forward movement of the vehicle.

In some instances, for example when using a trailer, it may be desirable to move a trailer independently of the vehicle under a power assisted drive. U.S. Pat. No. 6,945,343 belonging to Moreau et al. discloses an example of a motorised drive for an auxiliary wheel at the leading end of a trailer. The auxiliary wheel remains pivotal about an upright axis relative to the trailer in a free pivot so that the direction of the drive being applied by the auxiliary drive must be manually controlled by the operator. The auxiliary drive has no use when the trailer is coupled to a towing vehicle and thus provides no solution to the problem of increased engine demand when towing a trailer.

It is thus desirable to provide an arrangement wherein a motorised vehicle can pull a trailer and a load without having to relying on purchasing a relatively large engine by transferring power requirements to an auxiliary drive device which can help accelerate and decelerate the trailer and the load independently of the motorised vehicle. It is also desirable to provide motorised vehicles when not pulling a trailer the ability to operate the engine at peak efficiency, use regenerative braking and allow to power from the grid by adding an auxiliary drive device that can enable these functions to reduce fuel consumptions and permit hybridization and electrification of the powertrain. This aspect is important as there are over 800 million vehicles worldwide which are not hybridized and not grid connected.

### SUMMARY OF THE INVENTION

According to one aspect of the invention there is provided an auxiliary drive device for use with a vehicle having a chassis supported for rolling movement on the ground and a primary drive for driving rolling movement of the vehicle, the device comprising:

a mounting frame arranged to be mounted onto the vehicle in a substantially fixed relation to the vehicle chassis;

at least one auxiliary drive wheel supported on the mounting frame and arranged to engage the ground; and

a motor arranged to drive said at least one auxiliary drive wheel engaged with the ground.

By providing an auxiliary drive which can be coupled in fixed relation to a vehicle chassis, the direction of driving force of the auxiliary drive remains aligned with the forward movement of the vehicle to provide additional force as required during peak demands of the engine of the vehicle in a configuration which is much more stable than the prior art. Even when no trailer is present, by mounting the auxiliary drive wheel and motor directly to the chassis of the vehicle in fixed relation thereto, auxiliary drive can be provided to the vehicle when there is increased demand on the engine of the vehicle during acceleration, for example. This also allows the vehicle to operate using grid electricity as another source of power.

Preferably there is provided a controller arranged to control operation of the motor responsive to a condition of the vehicle. The controller may be arranged to be connected to the vehicle through a serial bus connection

The controller may include a sensor arranged to detect an acceleration or deceleration condition of the mounting frame and operate the motor responsive to the sensed condition, the sensor of the controller being operable independently of the vehicle.

The sensor may be arranged to sense an acceleration or deceleration condition of the mounting frame relative to the vehicle.

There may be provided an energy storage device arranged to store energy of the vehicle during braking and controllably release the stored energy during acceleration and constant velocity of the vehicle.

There may be provided an energy storage device arranged to supply power to the motor and a generator arranged to charge the energy storage device, the generator being operable responsive to a condition of the vehicle.

The generator may be operable responsive to a braking condition of the vehicle.

There may be provided a controller arranged to supply energy from the energy storage device to operate other electrical loads when the vehicle is moving, parked or disconnected from the auxiliary drive device, the controller being operable responsive to a user request to conserve stored energy.

The mounting frame and said at least one drive wheel supported thereon may be arranged to be readily separable together from the chassis of the vehicle.

The mounting frame may be arranged to be mounted onto a hitch attachment on the vehicle in place of a conventional hitch ball stem.

A suspension mechanism preferably supports said at least one auxiliary drive wheel for movement relative to the mounting frame.

The motor may comprise an electric motor arranged to receive power from an energy storage device supported on the mounting frame.

There may be provided a generator coupled to said at least one auxiliary drive wheel and arranged to charge the energy storage device, the generator and the energy storage device being carried on the mounting frame.

The generator, the energy storage device and the motor may be readily separable from the chassis of the vehicle together with the mounting frame.

There may be provided an energy storage device arranged to provide electrical power to the motor and a generator arranged to store energy in the energy storage device, the generator being driven by said at least one drive wheel.

There may be provided an energy storage device arranged to provide power to the motor and a generator arranged to store energy in the energy storage device, the generator being driven by wheels engaging the ground which differ from said at least one auxiliary drive wheel.

There may be provided a hitch connection on the mounting frame and arranged to connect a trailer thereto for free pivotal movement about an upright trailer axis relative to the mounting frame.

The device may be provided in combination with a trailer frame supported for rolling movement at a trailing end on trailing wheels and supported at a leading end on the mounting frame.

There may be provided an energy storage device arranged to supply energy to drive the motor and a generator arranged to store energy in the energy storage device, the generator being coupled to the wheels of the trailer.

The mounting frame may be readily separable from the chassis of the vehicle with said at least one drive wheel and the motor.

There may be provided a steering control arranged to steer said at least one drive wheel relative to the trailer frame when the trailer frame is separated from the chassis of the vehicle.

The mounting frame and the trailer frame may be arranged to be fixed in relative orientation when the mounting frame is separated from the chassis of the vehicle.

The steering control may comprise a power assisted drive arranged to steer at least one drive wheel relative to the trailer frame.

The motor may receive electrical power from an electrical storage device, the electrical storage device being arranged to be charged using grid electricity.

According to a second aspect of the present invention there is provided an auxiliary drive device for use with a towing vehicle having a chassis supported for rolling movement on the ground and a primary drive for driving rolling movement of the vehicle, the device comprising:

a trailer frame extending in a longitudinal direction between a leading end and a trailing end;

a plurality of trailing wheels arranged to support the trailing end of the trailer frame for rolling movement along the ground in the longitudinal direction;

a mounting frame arranged for selectively connecting the trailer frame to the chassis of the vehicle for relative pivotal movement about an upright trailer axis;

at least one drive wheel arranged to support the leading end of the trailer frame for rolling movement along the ground when the trailer frame is separated from the chassis of the vehicle;

said at least one drive wheel being arranged to engage the ground when the trailer frame is connected to the chassis of the vehicle; and
a motor arranged to drive said at least one auxiliary drive wheel in a first mode of operation when the trailer frame is connected to the chassis of the vehicle and in a second mode of operation when the trailer frame is separated from the chassis of the vehicle.

By providing a drive wheel arranged to engage the ground both when the trailer is attached to the towing vehicle and when it is separated from the towing vehicle, the motor driving the drive wheel can be arranged to provide both supplemental power to the engine of the vehicle for towing needs as well as providing power assisted drive to move the trailer about when it is separate and independent from the vehicle.

There may be provided a steering control arranged to steer at least one drive wheel relative to the trailer frame when the trailer frame is separated from the chassis of the vehicle.

The mounting frame may be arranged to be fixed relative to the trailer frame when the mounting frame is separated from the chassis of the vehicle, and wherein said at least one drive wheel is steerable relative to the mounting frame.

The mounting frame and the trailer frame may be arranged to be fixed in relative orientation when the mounting frame is separated from the chassis of the vehicle.

The steering control may comprise a power assisted drive arranged to steer at least one drive wheel relative to the trailer frame.

The motor may comprise an electric motor driven by an energy storage device supported on the mounting frame.

The motor may comprise an electric motor driven by an energy storage device supported on the trailer frame.

There may be provided a generator arranged to charge an energy storage device which drives the motor, the generator being driven by the trailing wheels of the trailer frame.

There may be provided a generator arranged to charge an energy storage device which drives the motor, the generator being driven by said at least one drive wheel.

The motor may receive electrical power from an electrical storage device, the electrical storage device being arranged to be charged using grid electricity.

According to a further aspect of the present invention there is provided an auxiliary drive device for use with a towing vehicle having a chassis supported for rolling movement on the ground and a primary drive for driving rolling movement of the vehicle, the device comprising:

a trailer frame extending in a longitudinal direction between a leading end and a trailing end;

a plurality of trailing wheels arranged to support the trailing end of the trailer frame for rolling movement along the ground in the longitudinal direction;

a mounting frame arranged for selectively connecting the trailer frame to the chassis of the vehicle for relative pivotal movement about an upright trailer axis;

at least one drive wheel arranged to support the leading end of the trailer frame for rolling movement along the ground when the trailer frame is separated from the chassis of the vehicle;

a motor arranged to drive said at least one auxiliary drive wheel; and

a steering control arranged to steer said at least one drive wheel relative to the trailer frame when the trailer frame is separated from the chassis of the vehicle.

By providing a steering control which is arranged to steer the drive wheel of the trailer frame, the trailer is not dependent upon an operator manually directing the direction of the auxiliary drive when displacing the trailer under powered drive independently of the towing vehicle.

The mounting frame may be arranged to be fixed relative to the trailer frame when the mounting frame is separated from the chassis of the vehicle, and wherein said at least one drive wheel is steerable relative to the mounting frame.

The mounting frame and the trailer frame may be arranged to be fixed in relative orientation when the mounting frame is separated from the chassis of the vehicle.

The steering control may comprise a power assisted drive arranged to steer at least one drive wheel relative to the trailer frame.

The motor may comprise an electric motor driven by a battery supported on the mounting frame.

The motor may comprise an electric motor driven by a battery supported on the trailer frame.

There may be provided a generator for charging a battery which drives the motor, the generator being driven by the trailing wheels of the trailer frame.

There may be provided a generator for charging a battery which drives the motor, the generator being driven by said at least one drive wheel.

The motor may receive electrical power from an electrical storage device, the electrical storage device being arranged to be charged using grid electricity.

There may be provided an energy storage device for storing electrical power and an output arranged for supplying electrical power from the energy storage device to another electrical device for use as an auxiliary power unit.

There may be provided a storage device for storing electrical power and an output arranged for supplying electrical power from the storage device to an electrical system of the vehicle.

Said at least one drive wheel may be supported on the mounting frame such that the drive wheel is supported for limited relative movement about an upright axis in a range of a few degrees relative to the vehicle chassis.

Said at least one drive wheel may be supported for limited relative movement about an upright axis relative to the vehicle chassis by a resilient mount which resiliently supports the mounting frame relative to the vehicle chassis.

Said at least one drive wheel may be biased towards a central orientation in which the drive wheel is oriented in a direction of forward rolling movement of the vehicle.

Some embodiments of the invention will now be described in conjunction with the accompanying drawings.

### BRIEF DESCRIPTION OF THE DRAWINGS

FIG. 1 is a perspective view of the auxiliary drive device according to a first embodiment in which the device is shown supporting a trailer frame thereon.

FIG. 2 is perspective view of a second embodiment of the auxiliary drive device shown in part with two motorized drive wheels.

FIG. 3 is a top plan view of a trailer frame shown freely pivoted relative to the mounting frame when the mounting frame is fixed to a towing vehicle according to the second embodiment of the auxiliary drive device.

FIG. 4 is a top plan view of the drive wheels pivoted relative to the mounting frame under steering control when the mounting frame and trailer frame are fixed relative to one another and separated from the towing vehicle according to the second embodiment of the auxiliary drive device.

In the drawings like characters of reference indicate corresponding parts in the different figures.

### DETAILED DESCRIPTION

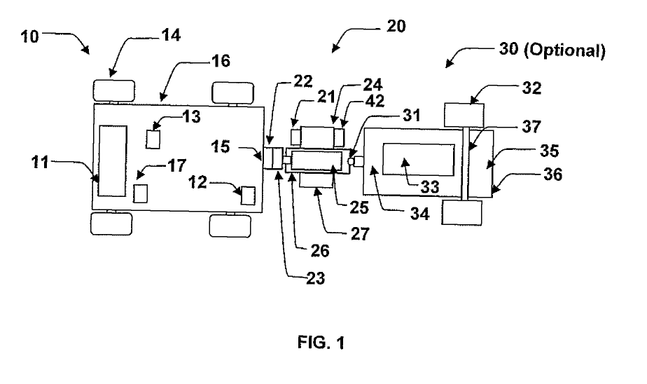

Referring to the accompanying FIGS. 1 to 4 there is illustrated an auxiliary drive device generally indicated by reference numeral 20. The auxiliary drive device 20 is particularly suited for use with vehicle 10 to supplement the drive power of the vehicle in a first instance, and to optionally provide motive drive to a trailer 30 and a load 33 when optionally connected in a second instance. The auxiliary drive device 20 allows hybrid through the road by extracting power from a primary motor 11 of the vehicle and allows regenerative braking of the vehicle 10 and optionally the trailer 30 and the load 33 when connected.

The vehicle 10 with which the auxiliary drive device 20 is used includes a vehicle chassis 16 supported for rolling movement along the ground on respective wheels 14. A primary motor 11 is supported on the vehicle chassis 16 of the vehicle 10 to drive the rolling movement of the vehicle along the ground. In some embodiments the vehicle chassis includes a hitch attachment 15 fixed thereon at the rear end of the vehicle which typically takes the form of a socket suitable for receiving the stem of a hitch ball therein for normal use of a trailer connected thereto.

The auxiliary drive device 20 comprises a mounting frame 26 which is arranged to be selectively mounted onto the vehicle chassis 16 of the vehicle 10 in a substantially fixed relationship therebetween.

The mounting frame 26 can be selectively attached or removed from vehicle chassis 16 by a suitable releasable bracket. In one embodiment the mounting frame 26 includes a stem arranged to be received with the socket of a typical hitch attachment bracket on the vehicle chassis for relative interconnection therebetween in fixed relative orientation. In further embodiments other configurations of brackets may be used to selectively fix mount the mounting frame 26 of the auxiliary drive device 20 in a readily releasable manner onto the vehicle chassis 16.

A push plate or force sensor 23 is provided on the mounting frame 26 close to the point of substantially fixed attachment onto the vehicle chassis 16 so as to be arranged to sense the force between the vehicle 10 and the auxiliary drive device 20. More particularly, the force sensor 23 is arranged to sense relative acceleration and deceleration forces primarily in the longitudinal direction between the vehicle chassis and the mounting frame 26. The force can be sensed by a plurality of methods that include for example the displacement of linear springs and dashpots, a pressure sensor and a strain gauge sensor. The signal is fed to a controller 21 to determine the force and then the operational mode of the auxiliary drive device 20. By controlling the electric motor 27 and the generator 40, the force can be modified to correspond to an optimal parameter.

The trailer 30 of the illustrated embodiment comprises a frame 36 extending in a longitudinal direction between a leading end 34 and a trailing end 35. The trailer frame comprises at least one longitudinal frame member extending in the longitudinal direction between the leading and trailing ends of the trailer and at least one lateral frame member 37.

Trailing wheels 32 are supported at opposing ends of lateral frame member 37 at the trailing end of trailer frame 36 to support the trailer for rolling movement in the longitudinal direction. The leading end 34 of trailer frame 36 includes suitable hitch ball connector 31 thereon for connection to a typical towing vehicle hitch ball or like connector. The connector at the leading end of the trailer frame is arranged to support the trailer for pivoting movement about a vertical trailer axis relative to vehicle 10.

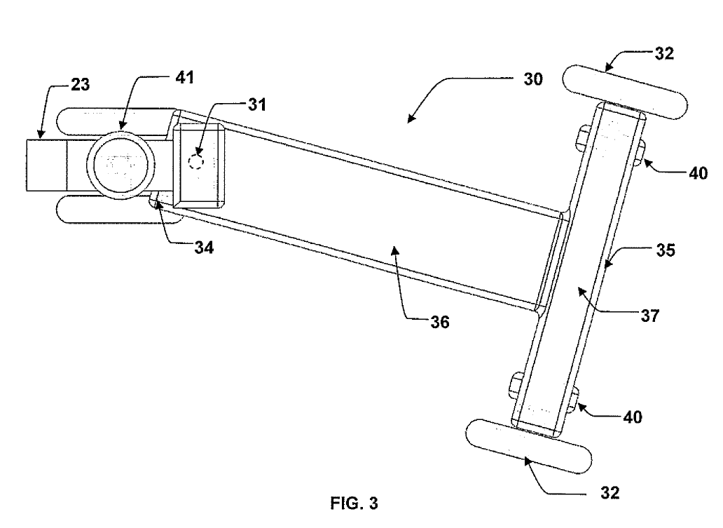

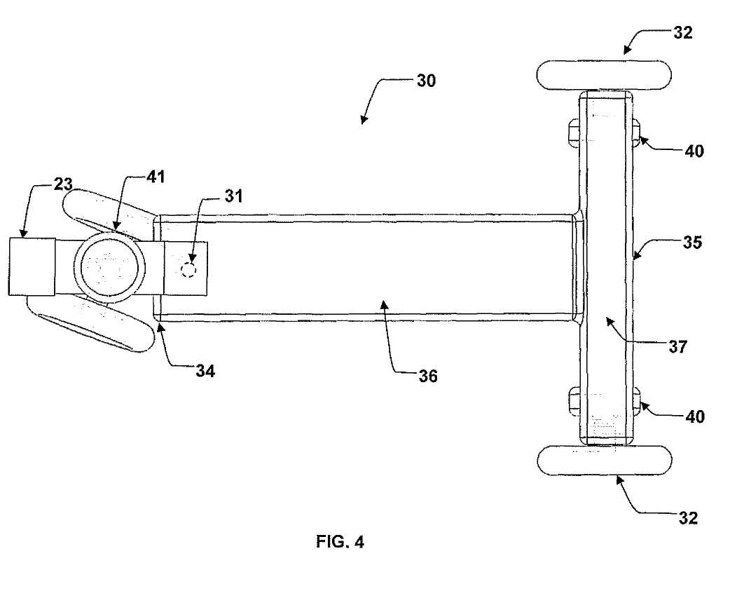

The mounting frame 26 includes a trailer attachment thereon spaced rearwardly from the attachment point to the chassis of the vehicle such that the mounting frame is configured to connect to the vehicle at a leading end thereof and support the leading end of the trailer pivotally thereon at the trailing end thereof. When the mounting frame 26 is fixed onto the vehicle 10, the trailer frame 36 remains freely pivotal relative to the mounting frame 26 of the auxiliary drive device 20 about a vertical axis at the trailing end of the mounting frame, as shown in FIG. 3. Alternatively when mounting frame 26 is separated from the vehicle chassis 16, the mounting frame and the trailer frame can be fixed relative to one another in a common longitudinal direction, as shown in FIG. 4.

The mounting frame 26 supports at least one drive wheel 25 thereon for engagement with the ground both when the mounting frame 26 is attached to vehicle 10 and when the mounting frame 26 is separated from the vehicle. The drive wheel 25 is supported for rotation on an axle upon which the mounting frame 26 is supported by a suitable suspension mechanism 28 coupled therebetween.

The drive wheel 25 can be steered about a vertical steering axis which is spaced forwardly of the trailer connection to the mounting frame so that the steering axis of the drive wheels relative to the mounting frame is spaced between the leading end of the mounting frame for connection to the chassis of the vehicle and the trailing end of the mounting frame locating the trailer axis about which the trailer is pivotal relative to the mounting frame.

The mounting frame 26 is supported on the vehicle 10 for near zero degrees of freedom therebetween. More particularly however, an angle adjuster 22 is coupled between the mounting frame and the vehicle. The angle adjuster offers some limited bending flexibility in the horizontal plane so that the drive wheel 25 is permitted some limited pivotal movement about a substantially vertical axis about a few degrees of rotation relative to the vehicle. The angle adjuster maintains orientation of the drive wheel substantially in the forward moving direction of the vehicle but allows the drive wheel to vary slightly in orientation relative to the wheels of the vehicle to compensate for the drive wheel 25 not having the same turning radius as the wheels 14 of the vehicle 10 so as to avoid premature wear of tire of drive wheel 25. The angle adjuster is located in front of the push plate and the mounting frame coupled thereto so as to be located between the push plate and the vehicle.

The drive wheel 25 is thus supported on the mounting frame such that the drive wheel is supported for limited relative movement about an upright axis in a range of a few degrees relative to the vehicle chassis by a resilient mount which resiliently supports the mounting frame relative to the vehicle chassis. The resilient mount biases the drive wheel 25 towards a central orientation in which the drive wheel is oriented in a direction of forward rolling movement of the vehicle.

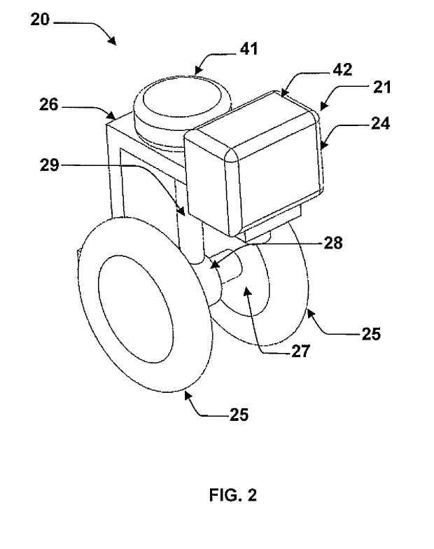

As shown in the embodiment of FIG. 1, only one drive wheel 25 is provided. Alternatively, in the embodiment of FIG. 2, two drive wheels 25 are provided on a common axle upon which the mounting frame is supported by suitable suspension as described above.

In the alternative embodiment of FIG. 2, a motorised electric drive 41 controls the angular orientation of the drive wheels relative to the mounting frame about the vertical steering axis using axle 29 to provide steering control of the drive wheels relative to the mounting frame, as shown in FIG. 2. When the mounting frame is intended to be fixed mounted to the chassis of a vehicle, the motorised electric drive 41 orients the drive wheels to remain fixed in orientation relative to the mounting frame for being generally fixed relative to the vehicle for rolling movement in the longitudinal direction of the mounting frame and of the vehicle, while the trailer remains freely pivotal about the respective trailer axis, as shown in FIG. 3.

Alternatively when the device is separated from vehicle 10, the mounting frame 26 is fixed relative to the trailer frame so that there is no longer any relative pivotal movement about the trailer axis, and the motorised electric drive 41 is thus used to controllably steer the drive wheels 25 relative to the mounting frame and trailer frame about the respective steering axis thereof, as shown in FIG. 4. The motorised electric drive 41 can be used to compensate for the drive wheels not being in the same turning radius as the wheels 14 when the vehicle 10 is turning instead of using an angle adjuster 22 as described above with regard to the first embodiment.

In either embodiment, an electric motor 27 is provided for driving drive wheel 25. That is the electric motor 27 provides drive to drive rotation of the drive wheel engaged with the ground when the mounting frame is attached to a vehicle regardless of a trailer being attached thereto to supplement the drive provided by the primary motor 11 of vehicle 10. The electric motor 27 also provides power to drive the rotation and rolling movement of the wheels when the mounting frame is separated from the vehicle and fixed to the trailer frame during which the orientation of the drive wheels about the steering axis is controlled. The electric motor 27 can also be operated as a motor generator to allow regenerative braking and hybrid through the road to extract power from the primary motor 11. This added function requires reconfiguration of the motor driver of electric motor 27.

In the illustrated embodiment in FIG. 1, an energy storage device 24 provides electric power to drive the electric motor 27. The energy storage device 24 can consists of a plurality of energy systems which includes a battery, ultracapacitors, flywheels, mechanical systems or hydraulic systems. Alternatively it can also consist of a solid, liquid or gaseous renewable and non-renewable fuel storage used in conjunction with an energy conversion device to drive an electric generator to produce electricity. Safety provision for collision and temperature control for the energy storage device 24 varies depending on the system selected. The energy storage device 24 is normally mounted on mounting frame 26. Alternatively it can also be mounted on trailer frame 36 or vehicle chassis 16 both methods requiring a quick disconnect connector. When the energy storage 24 is supported on mounting frame 26, auxiliary drive device 20 is separable from vehicle chassis 10 and trailer 30.

At least one generator 40 is provided and located on mounting frame 26 and combined with an electric motor 27 using a generator/motor arrangement. In alternative arrangements the generator 40 can be coupled to drive wheel 25 of auxiliary drive device 20. In an alternative embodiment, as illustrated in FIGS. 3 and 4, two generators 40 are supported on trailing wheels 32 of trailer frame 36, respectively. In all instance the generator serves to charge up or store energy in the energy storage device 24 for subsequent use in driving the electric motor 27 in two distinct modes: regenerative braking to decelerate vehicle 10, auxiliary drive device 20 and trailer 30 if connected, and to extract power from the primary motor by using hybrid through the road. A power converter 42 is used to manage the conversion from DC to AC and AC to DC between electrical components and to allow grid power to charge energy storage 24. Grid connection can be accomplished by connecting an extension cord and plug to auxiliary drive device 20 when stationary or via a tethered connection when in motion.

A controller 21 is provided for controlling the operations of the electric motor 27 to drive the drive wheels and of the engagement of generator 40 with the respective wheels that drive its rotation. In a preferred embodiment, the controller 21 comprises a module which receives inputs from only the push plate or force sensor 23 and the state of charge of energy storage 24. In other embodiments, controller 21 additionally obtains input from a trailer plug 12 located in vehicle 10. In yet a further embodiment, the controller 21 is readily plugged into serial bus connection 17 located in vehicle 10, for example a Can-Bus configuration. The serial bus connection may be included as part of the electrical connector plug to which the trailer would be electrically coupled.

User inputs entered using a device located in the vehicle 10 or the auxiliary drive device 20 can also be provided to the controller 21 to override how much of the energy will be drained from the energy storage device 24 determined by a control algorithm. The controller 21 will autonomously operate the electric motor 27 and the connection of the generator 40 based on detected conditions of the vehicle through its various inputs. Both the electric motor 27 and the generator 40 are thus responsive to detected vehicle 10 and the trailer 30 conditions so that the motor can be operated to supplement power for driving movement of the vehicle when needed to supplement the primary motor 11 of vehicle 10 while the generator 40 can be operated either to continuously provided some charging to the energy storage device 24 or more particularly to brake the vehicle by selective connection of the generator with wheels of auxiliary drive device 20 to provide regenerative braking capabilities to the vehicle and hybrid through the road. The controller can also provide feedback control to dampen the dynamic vibrations provided by trailer 30.

Based on the controller inputs, controller 21 can be optimized to reduce fuel consumption, enhance performance when pulling a loaded trailer and determine when to add generator load and operate the electric motor. For example, the generator can be connected to the drive wheel to provide a light load on the vehicle to store electric power in energy storage 24 to operate the vehicle engine at its peak efficiency and use the energy for subsequent use when there is an increased demand on primary motor 11 of vehicle 10. In this instance controller 21 directs electric motor 27 of drive wheel 25 to provide the additional driving force to the vehicle while maintaining the engine of the vehicle at its peak operating efficiency range to increase the overall efficiency of vehicle 10. In another instance, drive wheel 25 is activated mostly during the beginning of the acceleration of the vehicle when primary motor efficiency is low due to large torque requirements at low speed.

In some modes controller 21 can be operated to function as a hybrid conversion of a typically internal combustion engine driven vehicle. When the energy storage is charged using grid electricity, the controller can be operated to function as a plug-in hybrid conversion of a typically internal combustion engine driven vehicle. In both instances the mounting frame is fixed to the chassis of the vehicle with electric motor 27, energy storage 24, and generator 40 and coupled to drive wheel 25.

As described herein auxiliary drive device 20 has many uses and advantages over the prior art. In a first mode, the mounting frame can be used separate from the trailer frame with the electric motor 27, energy storage 24 and generator 40 to provide a hybrid supplemental power to a vehicle in which the supplemental power is delivered to auxiliary drive wheel 25. In a further mode of operation, the trailer frame can be attached to the mounting frame on the vehicle so that electric motor 27 instead provides supplemental towing power to the vehicle for handling the increased demands upon the engine of the vehicle due to a load being carried on the trailer frame. In yet a further mode of operation the device can be operated independently of a vehicle for providing motive driving force to a trailer frame connected to the mounting frame and separated from the vehicle.

The auxiliary drive device 20 can also be used as an auxiliary power unit either while attached to the vehicle to power auxiliary load 13 on vehicle 10 or as a standalone unit. More particularly, auxiliary drive device 20 can be readily detached from the vehicle for independent use in supplying electricity when not near an active electrical outlet. In this instance, a suitable electrical socket or female receptacle is provided on the housing for mating connection with a plurality of electrical consuming devices. Applications include using the auxiliary drive device 20 to power devices when camping, tools at a job site, and provide critical power to a home during a power failure. In other applications, the trailer frame can be used when towed by a vehicle to charge the auxiliary drive device 20 with electrical power while driving under power from the engine of the vehicle so that electrical power is readily available upon arrival to a destination from energy that came from primary motor 11 that was generated by auxiliary power device 20 via hybrid through the road. The auxiliary drive device in a preferred embodiment is arranged to be charged either by grid electricity, by regenerative braking using a generator driven by the wheels of the device during braking or by the engine of the vehicle passing energy that is picked up by generator 40.

In yet further preferred embodiments auxiliary drive device 20 can be connected to any vehicle without modification to the vehicle being required due to the configuration of the controller. The controller 21 includes a force sensor to detect acceleration and deceleration conditions of vehicle 10 independent of any control systems onboard vehicle 10. The controller 21 accordingly receives the required information from push plate 23 to sense the force exerted onto vehicle 10 by auxiliary power device 20. This force can be positive or negative according to relative acceleration or deceleration between the auxiliary drive device and the vehicle as sensed by controller 21 and is used by the controller to decide when and how much power is applied by the auxiliary power device to supplement motive force to the motion of the vehicle as well as to be used by the controller to decide when and to what degree a regenerative braking mode is used to charge the energy storage device 24 of the auxiliary drive device 20. The controller can also determine the appropriate action to be taken using the sensed velocity of auxiliary power device 20 and the velocity of vehicle 10 by reading the CanBus, in combination with the force sensor mechanism. The controller can also use other sensors and have multiple configurations. Based on the vehicle type, the maximum force that the auxiliary drive device 20 can impart to the vehicle is within limits that are determined based on manufacturer specifications as to keep stresses within design limits of vehicle chassis 16.

Using a preferred embodiment of auxiliary drive device 20 an internal combustion engine driven vehicle can be readily operated as a hybrid or plug-in electrical hybrid vehicle without any modification to the vehicle itself being required and thus the advantages of hybrids and plug-in hybrids can be readily realized without difficult or costly modifications to vehicles themselves that voids warranties or requires recertification of engine emissions which can be costly. According to the present invention, a mounting frame supporting at least one wheel thereon which is driven by an electric motor receiving power through various means described above is all that is required for hybrid conversion of a conventional internal combustion engine vehicle.

In further embodiments, the electric motor can be replaced with a hydraulic motor. In this instance, the energy storage device would comprise a suitable hydraulic system to permit the motor to store energy in the energy storage device for regenerative braking ability.

Since various modifications can be made in this invention as herein above described, and many apparently widely different embodiments of same made within the spirit and scope of the claims without department from such spirit and scope, it is intended that all matter contained in the accompanying specification shall be interpreted as illustrative only and not in a limiting sense. For example, adding a gearbox or a secondary electric motor to the auxiliary drive device to develop better torque and efficiency characteristics curves does not change the intent of the disclosure.

1. An auxiliary drive device for use with a vehicle having a chassis supported for rolling movement on the ground and a primary drive for driving rolling movement of the vehicle, the device comprising:
a mounting frame arranged to be mounted onto the vehicle in a substantially fixed relation to the vehicle chassis;
at least one auxiliary drive wheel supported on the mounting frame and arranged to engage the ground; and
a motor arranged to drive said at least one auxiliary drive wheel engaged with the ground.

2. (canceled)

3. (canceled)

4. The device according to claim 1 wherein there is provided a controller arranged to control operation of the motor responsive to a condition of the vehicle and wherein the controller includes a sensor arranged to detect an acceleration or deceleration condition of the mounting frame and operate the motor responsive to the sensed condition, the sensor of the controller being operable independently of the vehicle.

5. (canceled)

6. (canceled)

7. (canceled)

8. (canceled)

9. The device according to claim 1 wherein there is provided an energy storage device arranged to supply power to the motor and a generator arranged to charge the energy storage device, the generator being operable responsive to a condition of the vehicle and wherein there is provided a controller arranged to supply energy from the energy storage device to operate other electrical loads when the vehicle is moving, parked or disconnected from the auxiliary drive device, the controller being operable responsive to a user request to conserve stored energy.

10. (canceled)

11. (canceled)

12. (canceled)

13. (canceled)

14. (canceled)

15. The device according to claim 1 wherein the motor comprises an electric motor arranged to receive power from an energy storage device supported on the mounting frame, wherein there is provided a generator coupled to said at least one auxiliary drive wheel and arranged to charge the energy storage device in which the generator and the energy storage device are carried on the mounting frame and wherein the generator, the energy storage device and the motor are readily separable from the chassis of the vehicle together with the mounting frame.

16. (canceled)

17. The device according to claim 1 wherein there is provided an energy storage device arranged to provide power to the motor and a generator arranged to store energy in the energy storage device, the generator being driven by wheels engaging the ground which differ from said at least one auxiliary drive wheel.

18. (canceled)

19. The device according to claim 1 in combination with a trailer frame supported for rolling movement at a trailing end on trailing wheels and supported at a leading end on the mounting frame.

20. The device according to claim 19 wherein there is provided an energy storage device arranged to supply energy to drive the motor and a generator arranged to store energy in the energy storage device, the generator being coupled to the wheels of the trailer.

21. The device according to claim 19 wherein the mounting frame is readily separable from the chassis of the vehicle with said at least one drive wheel and the motor.

22. The device according to claim 21 wherein there is provided a steering control arranged to steer said at least one drive wheel relative to the trailer frame when the trailer frame is separated from the chassis of the vehicle.

23. The device according to claim 19 wherein the mounting frame and the trailer frame are arranged to be fixed in relative orientation when the mounting frame is separated from the chassis of the vehicle.

24. The device according to claim 19 wherein the steering control comprises a power assisted drive arranged to steer at least one drive wheel relative to the trailer frame.

25. (canceled)

26. An auxiliary drive device for use with a towing vehicle having a chassis supported for rolling movement on the ground and a primary drive for driving rolling movement of the vehicle, the device comprising:
a trailer frame extending in a longitudinal direction between a leading end and a trailing end;
a plurality of trailing wheels arranged to support the trailing end of the trailer frame for rolling movement along the ground in the longitudinal direction;
a mounting frame arranged for selectively connecting the trailer frame to the chassis of the vehicle for relative pivotal movement about an upright trailer axis;
at least one drive wheel arranged to support the leading end of the trailer frame for rolling movement along the ground when the trailer frame is separated from the chassis of the vehicle;
said at least one drive wheel being arranged to engage the ground when the trailer frame is connected to the chassis of the vehicle; and
a motor arranged to drive said at least one auxiliary drive wheel in a first mode of operation when the trailer frame is connected to the chassis of the vehicle and in a second mode of operation when the trailer frame is separated from the chassis of the vehicle.

27. The device according to claim 26 wherein there is provided a steering control arranged to steer at least one drive wheel relative to the trailer frame when the trailer frame is separated from the chassis of the vehicle.

28. The device according to claim 27 wherein the mounting frame is arranged to be fixed relative to the trailer frame when the mounting frame is separated from the chassis of the vehicle, and wherein said at least one drive wheel is steerable relative to the mounting frame.

29. The device according to claim 26 wherein the mounting frame and the trailer frame are arranged to be fixed in relative orientation when the mounting frame is separated from the chassis of the vehicle.

30. (canceled)

31. (canceled)

32. (canceled)

33. The device according to claim 26 wherein there is provided a generator arranged to charge an energy storage device which drives the motor, the generator being driven by the trailing wheels of the trailer frame.

34. (canceled)

35. (canceled)

36. An auxiliary drive device for use with a towing vehicle having a chassis supported for rolling movement on the ground and a primary drive for driving rolling movement of the vehicle, the device comprising:
a trailer frame extending in a longitudinal direction between a leading end and a trailing end;
a plurality of trailing wheels arranged to support the trailing end of the trailer frame for rolling movement along the ground in the longitudinal direction;
a mounting frame arranged for selectively connecting the trailer frame to the chassis of the vehicle for relative pivotal movement about an upright trailer axis;
at least one drive wheel arranged to support the leading end of the trailer frame for rolling movement along the ground when the trailer frame is separated from the chassis of the vehicle;
a motor arranged to drive said at least one auxiliary drive wheel; and
a steering control arranged to steer said at least one drive wheel relative to the trailer frame when the trailer frame is separated from the chassis of the vehicle.

37. The device according to claim 36 wherein the mounting frame is arranged to be fixed relative to the trailer frame when the mounting frame is separated from the chassis of the vehicle, and wherein said at least one drive wheel is steerable relative to the mounting frame.

38. (canceled)

39. (canceled)

40. (canceled)

41. (canceled)

42. The device according to claim 36 wherein there is provided a generator for charging a battery which drives the motor, the generator being driven by the trailing wheels of the trailer frame.

43. (canceled)

44. (canceled)

45. (canceled)

46. (canceled)

47. The device according to claim 1 wherein said at least one drive wheel is supported on the mounting frame such that the drive wheel is supported for limited relative movement about an upright axis in a range of a few degrees relative to the vehicle chassis.

48. (canceled)

49. (canceled)
